(19) United States
(12) Patent Application Publication
(10) Pub. No.: US 2005/0097583 A1
(43) Pub. Date: May 5, 2005

(54) Complex electronic device having circuit board for operation button control and device units connected by bent or folded flexible flat cables

(75) Inventor: Yoshihiro Okumura, Takefu-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Takefu-city (JP)

(21) Appl. No.: 10/973,422

(22) Filed: Oct. 27, 2004

(30) Foreign Application Priority Data
Oct. 31, 2003 (JP) 2003-371943

(51) Int. Cl. G11B 15/04; G11B 19/04; G11B 33/12

(52) U.S. Cl. 720/652

(57) ABSTRACT

In a complex electronic device, in which device units are arranged so as to have substantially the same height of medium loading spaces, in connecting a circuit board for operation button control and each operation unit by use of FFCs, wiring in a limited space is possible even when the FFCs are bent or folded, without exerting an adverse effect on the arrangement of other parts. There is provided a complex electronic device in which in order to transmit operation signals of operation buttons of an optical disk recording/reading unit to an operation control circuit on a control circuit board of the unit, a connector (A) is arranged between the optical disk recording/reading unit and the control circuit board disposed below the optical disk recording/reading unit and on a side facing the front of devices on the control circuit board, and the connector (A) on the control circuit board and a connector (B) on the circuit board for operation button control are connected by a flexible flat cable that is bent or folded in a Z-shaped form by mountain folding and valley folding.

The present application is based on and claims priority of Japanese patent application No. 2003-371943 filed on Oct. 31, 2003, the entire contents of which are hereby incorporated by reference.

### BACKGROUND OF THE INVENTION

1. Field of the Invention

The present invention relates to a complex electronic device in which a circuit board for operation button control and device units are connected by bent or folded flexible flat cables and more particularly, to a complex electronic device in which an optical disk recording/reading unit, such as a DVD (digital versatile disk) drive and a video cassette recording and reading unit (VCR: video cassette recorder) are built, and a circuit board for operation button control and device units (a recording and reading unit and a recording/reading unit) are connected by bent or folded flexible flat cables.

It is self-evident that the present invention can be easily applied to electronic devices other than those described in embodiments without departing from the gist of the present invention. In the present invention, a recording and reading unit refers to a unit capable of recording and reading, and a recording/reading unit includes a unit capable of only reading or recording and a unit capable of both recording and reading. Of course, it is rare that only reading is capable in such a device. However, in the present invention, it is unnecessary to exclude such an device. Therefore, the terms are construed as described above.

In addition, in this patent specification, a flexible flat cable is hereinafter referred to as an FFC.

2. Description of the Related Art

In recent years, large-capacity recording/reading devices that use DVDs, hard disks and the like as media have been put to practical use, and at the same time, electronic devices combined with analog type video cassette recording and reading devices that have hitherto been used have been developed and marketed.

As internal layouts of such complex electronic device as described above, Japanese Patent Laid-Open No. 2002-50171 discloses, for example, an internal layout that a first reading unit and a second reading unit are horizontally arranged in parallel on a top surface of a chassis that forms a bottom surface of a cabinet and a board that constitutes a main control circuit or the like comprising a CPU or the like is provided on a back surface of a top-surface panel, and Japanese Patent Laid-Open No. 9-73766 discloses an internal layout in which circuit boards are arranged above and below a mechanical frame in an optical disk device.

In developing such complex electronic device as described above, by utilizing the fact that the outside dimension of an optical disk recording/reading unit is smaller in height than those of a video cassette recording and reading unit, the present inventors have been engaged with the development of electronic devices in which an optical disk recording/reading unit is supported by multiple supporting struts, the optical disk recording/reading unit and the video cassette recording and reading unit are arranged so that both have substantially the same height of loading space for a recording medium, and an empty space is ensured between the optical disk recording/reading unit and the bottom surface of the cabinet.

Such a complex electronic device as described above is provided with an operation panel, on the front surface of which are arranged operation buttons to operate each device unit (an optical disk recording/reading unit and a video cassette recording and reading unit), and on the back surface of the front operation panel is arranged a circuit board for operation button control that transmits the operation of each operation button to each unit, and the circuit board for operation button control and the control board of each unit are appropriately connected by cables.

In such an device as described above, there are an ordinary covered wire and a flat-shaped cable called an FFC usually used to provide electrical connections between multiple boards. The FFC enables multiple connection points to be simultaneously connected and has flexibility in a direction perpendicular to a flat surface due to its shape, thereby making wiring connection easy. However, it is very difficult to bend or fold the FFC in a horizontal direction paralleled to a flat surface. Therefore, in some cases, the position and direction of connectors cannot be freely determined on the board.

For this reason, when the FFC is used as a wire to provide electrical connections between the boards, it may sometimes be necessary to install the FFC by bending or folding it in appropriate positions. Usually, however, there are no prescribed bending or folding marks in the FFC. Therefore, the. FFC had the problem that when the FFC is bent or folded each time by eye measurement, the bending or folding positions are not accurate. For this reason, an FFC having earmarks on the surface and having widely formed flat conductor parts have been developed to predetermine the bending or folding positions in the FFC easily (Japanese Patent Laid-Open No. 8-203340). However, the FFC disclosed in this patent document only indicates positions where the FFC is to be bent or folded, and does not distinguish whether the FFC should be mountain-folded or valley-folded.

Considering the fact that the loading space of the device units (an optical disk recording/reading unit and a video cassette recording and reading unit)in an electronic device, particularly a complex electronic device, has substantially the same height, the problem to be solved by the present invention is to provide an electronic device in which, in connecting a circuit board for operation button control and each operation units by using the FFCs, wiring in a limited space is possible even when the FFCs are bent or folded, without exerting an adverse effect on the arrangement of other parts.

Furthermore, the object of the present invention is to provide an FFC in which mountain folded, valley folded or 90 degree folded that can accurately bend or fold at prescribed positions in order to avoid the cutting of a conductor, which may be caused by repeating the bending or folding of conductors at the same places multiple times, because bending or folding in wrong directions may occur if an FFC indicates only bending or folding lines, and because in this case, bending or folding back in a reverse direction must be carried out again.

### SUMMARY OF THE INVENTION

The present invention provides a complex electronic device in which within a cabinet are arranged an optical disk recording/reading unit having a front surface on which a loading space for an optical disk medium is provided and a video cassette recording and reading unit having a front surface on which a loading space for a video cassette medium is provided, and the units are supported by multiple supporting struts and arranged in parallel. The height of the supporting struts of the optical disk recording/reading unit is higher than the height of the supporting struts of the video cassette recording and reading unit so that the medium loading space have substantially the same height. The cabinet has a front surface on which a front operation panel is provided, and the front operation panel has operation buttons that operate each of the optical disk recording/reading unit and the video cassette recording and reading unit. On a back surface of the front operation panel is arranged a circuit board for operation button control that transmits the operation of each operation button to each units. And between the optical disk recording/reading unit and a bottom surface of the cabinet there is disposed a first control circuit board on which a control circuit of the optical disk recording/reading unit is provided and between the video cassette recording and reading unit and the bottom surface of the cabinet there is disposed a second circuit board on which a control circuit of the video cassette recording and reading unit is provided. In order to transmit operation signals of the operation buttons of the optical disk recording/reading unit to the operation control circuit on the first control circuit board, a connector (A) is arranged between the optical disk recording/reading unit and the first control circuit board disposed below the optical disk recording/reading unit and on a side facing the front of devices on the first control circuit board, and the connector (A) on the first control circuit board and a connector (B) on the circuit board for operation button control are connected by a flexible flat cable that is bent or folded in a Z-shaped form by mountain folding and valley folding.

Also, in the present invention, the FFC that is bent or folded in a Z-shaped form by mountain folding and valley folding is bent or folded at the back surface of the front operation panel, so as to be positioned below the loading space for an optical disk medium, thereby not to be a hindrance to the loading of an optical disk medium.

In the present invention there is provided a complex electronic device in which within a cabinet are arranged an optical disk recording/reading unit having a front surface on which a loading space for an optical disk medium is provided and a video cassette recording and reading unit having a front surface on which a loading space for a video cassette medium is provided, and the units are supported by multiple supporting struts and arranged in parallel. The height of the supporting struts of the optical disk recording/reading unit is higher than the height of the supporting struts of the video cassette recording and reading unit so that the medium loading space have substantially the same height. The cabinet has a front surface on which a front operation panel is provided, and the front operation panel has operation buttons that operate each of the optical disk recording/reading unit and the video cassette recording and reading unit. On a back surface of the front operation panel is arranged a circuit board for operation button control that transmits the operation of each operation button to each of the units. And between the optical disk recording/reading unit and a bottom surface of the cabinet there is disposed a first control circuit board on which a control circuit of the optical disk recording/reading unit is provided and between the video cassette recording and reading unit and the bottom surface of the cabinet there is disposed a second circuit board on which a control circuit of the video cassette recording and reading unit is provided. In order to transmit operation signals of the operation buttons of the video cassette recording and reading unit to the operation control circuit on the second control circuit board, a connector (C) is arranged between the video cassette recording and reading unit and the second control circuit board disposed below the video cassette recording and reading unit and on a side facing the side of devices on the second control circuit board, and the connector (C) on the second control circuit board and a connector (D) on the circuit board for operation button control are connected by a flexible flat cable that is bent or folded 90 degrees.

Also, in the present invention, the FFC is bent or folded 90 degrees extending from the connector (D) on the circuit board for operation button control along the side surface of the second control circuit board toward the back side of the device and is bent or folded 90 degrees above the connector (C).

In the present invention there is provided a complex electronic device in which within a cabinet are arranged an optical disk recording/reading unit having a front surface on which a loading space for an optical disk medium is provided and a video cassette recording and reading unit having a front surface on which a loading space for a video cassette medium is provided, and the units are supported by multiple supporting struts and arranged in parallel. The height of the supporting struts of the optical disk recording/reading unit is higher than the height of the supporting struts of the video cassette recording and reading unit so that the medium loading space have substantially the same height. The cabinet has a front surface on which a front operation panel is provided, and the front operation panel has operation buttons that operate each of the optical disk recording/reading unit and the video cassette recording and reading unit. On a back surface of the front operation panel is arranged a circuit board for operation button control that transmits the operation of each operation button to each units. And between the optical disk recording/reading unit and a bottom surface of the cabinet there is disposed a first control circuit board on which a control circuit of the optical disk recording/reading unit is provided and between the video cassette recording and reading unit and the bottom surface of the cabinet there is disposed a second circuit board on which a control circuit of the video cassette recording and reading unit is provided. In order to transmit operation signals of the operation buttons of the optical disk recording/reading unit to the operation control circuit on the first control circuit board, a connector (A) is arranged between the optical disk recording/reading unit and the first control circuit board disposed below the optical disk recording/reading unit and on a side facing the front of the devices on the first control circuit board, and the connector (A) on the first control circuit board and a connector (B) on the circuit board for operation button control are connected by a flexible flat cable that is bent or folded in a Z-shaped form by mountain folding and valley folding. Furthermore, in order to transmit operation signals of the operation buttons of the video cassette recording and reading unit to the operation control circuit on the second control circuit board, a connector (C) is arranged between the video cassette recording and reading unit and the second control circuit board disposed below the video cassette recording/and reading unit and on a side facing the side of devices on the second control circuit board, and the connector (C) on the second control circuit board and the connector (D) on the circuit board for operation button control are connected by a flexible flat cable that is bent or folded 90 degrees.

Also, in the present invention the FFC that is bent or folded in a Z-shaped form by mountain folding and valley folding is bent or folded, at the back surface of the front operation panel, so as to be positioned below the loading space for an optical disk medium, thereby not to be a hindrance to the loading of the optical disk medium, and the FFC that is bent or folded 90 degrees extends from the connector (D) on the circuit board for operation button control along the side surface of the second control circuit board toward the back side of the device and is bent or folded 90 degrees above the connector (C).

Furthermore, in the present invention there is provided an FFC that indicates the bending or folding positions, in which the indications specify a mountain folding or a valley folding positions at the respective indications, so that the mountain folding and valley folding can be accurately performed.

Furthermore, in the present invention there is provided an FFC that indicates a bending or folding position, in which an indication that specifies a position of 90 degree bending or folding is provided so that the 90 degree bending or folding can be performed in the position of the indication.

In the present invention, by connecting the connector (A) on the first control circuit board and the connector (B) on the circuit board for operation button control by using the FFC that is bent or folded in a Z-shaped form by mountain folding and valley folding as described above, it has become possible to effectively utilize the space below the optical disk medium loading space.

Furthermore, in the present invention, by connecting the connector (C) on the first control circuit board and the connector (D) on the circuit board for operation button control by using the FFC that extends from the connector (D) along the side surface of the second control circuit board toward the back side of devices, which is bent or folded 90 degrees above the connector (C), it has become possible to perform wiring in a slight gap on the side of devices, contributing to the miniaturization of device without requiring an extra length of the cable.

### BRIEF DESCRIPTION OF THE DRAWINGS

FIG. 1 is an outer perspective view of the whole complex electronic device according to an embodiment of the present invention;

FIG. 2 is a perspective view of a complex electronic device in which a top frame is removed;

FIG. 3 is an exploded perspective view that shows how parts are attached to a top surface of a bottom frame in an exploded manner;

FIG. 4 is a configuration front view of the whole complex electronic device according to an embodiment of the present invention;

FIG. 5 is a configuration perspective view of the whole complex electronic device according to an embodiment of the present invention;

FIG. 6 is a detail view that shows the state of connection between the connectors (A) and (B) by an FFC;

FIG. 7 is a detail view that shows the state of connection between the connectors (C) and (D) by an FFC;

FIG. 8 is a detail view of an FFC that is to be bent or folded in a Z-shaped form by mountain folding and valley folding;

FIG. 9 is a view that shows the state of an FFC that has been bent or folded in a Z-shaped form by mountain folding and valley folding;

FIG. 10 is a detail view of an FFC that is to be bent or folded 90 degrees; and

FIG. 11 is a view that shows the state of an FFC that has been bent or folded 90 degrees.

### DETAILED DESCRIPTION OF THE PREFERRED EMBODIMENTS

Now the preferred embodiments of the present invention will be described below with reference to the drawings. Please note that the following embodiments are merely examples for embodying the invention and are not intended to limit the invention within the scopes of the embodiments.

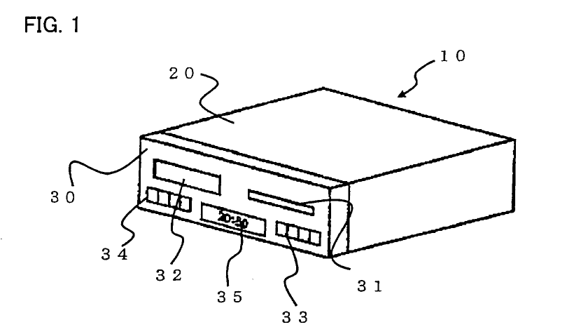

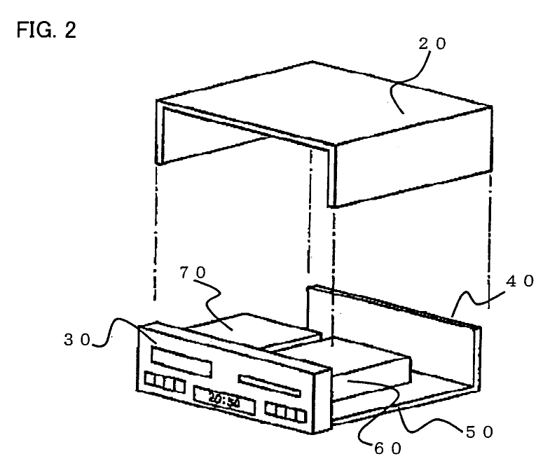

FIG. 1 is an outer perspective view of the whole complex electronic device 10, which is an embodiment of the present invention, and FIG. 2 is a perspective view of the complex electronic device in which a top frame 20 is removed. In a cabinet of the complex electronic device 10, the top frame 20, a front operation panel 30 and a back frame 40 are fixed to a bottom frame 50 by screwing (which is not shown because the screwing structure is not related to the invention).

To facilitate the building-in of a circuit board and the like, the top frame 20 is constructed in an angulated U-shaped form in such a manner that the top and sides of the cabinet are integrally formed and the top frame 20 opens in three directions. On the front operation panel 30, a loading slot 31 for a DVD medium and a loading slot 32 for a video cassette medium are formed so as to have almost the same height. Also, operation buttons 33 and 34 are disposed below the loading slots 31 and 32 to operate a DVD device and a VCR device, respectively, and a display part 35 is provided in the middle section. On the bottom frame 50, there are disposed a DVD recording/reading unit 60, a video cassette recording and reading unit 70, a circuit board (which is not shown in FIG. 2 because this is a drawing to show an outline of the frame construction) and the like, which are fixed by screwing. On the back surface of the front operation panel 30, there is disposed an operation signal control board that transmits button operation signals of the operation buttons 33 and 34 to each circuit board which will be described later.

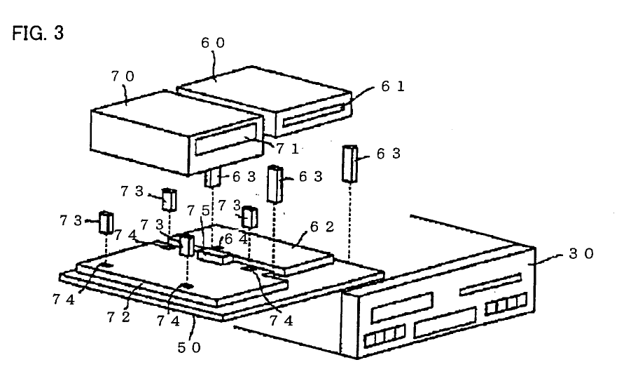

FIG. 3 is an exploded perspective view that shows how the units and parts are attached to the top surface of the bottom frame 50. On the bottom frame 50 are disposed the DVD recording/reading unit 60 and the video cassette recording and reading unit 70, which are arranged side by side.

The DVD recording/reading unit 60 is supported on the top surface of the bottom frame 50 by means of three supporting struts 63, 63, 63. The height of the DVD recording/reading unit 60 from the top surface of the bottom frame 50 is determined by the height of the supporting struts 63. The supporting struts 63 are fixed at the bottom ends thereof to the bottom frame 50 by screwing (not shown) and engaged and fixed at the top ends thereof to the bottom surface of the DVD recording/reading unit 60 by use of appropriate engaging means (not shown). Incidentally, the number of supporting struts 63 to be used or their positions is merely a design choice.

The video cassette recording and reading unit 70 is supported on the top surface of the bottom frame 50 by means of four supporting struts 73, 73, 73, 73. The height of the video cassette recording and reading unit 70 from the top surface of the bottom frame 50 is determined by the height of the supporting struts 73. The supporting struts 73 are fixed at the bottom ends thereof to the bottom frame 50 by screwing (not shown) and engaged and fixed at the top ends thereof to the bottom surface of the video cassette recording and reading unit 70 by use of appropriate engaging means (not shown). Incidentally, the number of supporting struts 73 to be used or their positions is merely a design choice.

By appropriately selecting and determining the height of the supporting struts 63 of the DVD recording/reading unit and the height of the supporting struts 73 of the video cassette recording and reading unit in this manner, it is possible to disclose the medium loading slot 61 of the DVD recording/reading unit 60 and a medium loading slot 71 of the video cassette recording and reading unit 70 with respect to the bottom surface 50 of the cabinet substantially at the same height.

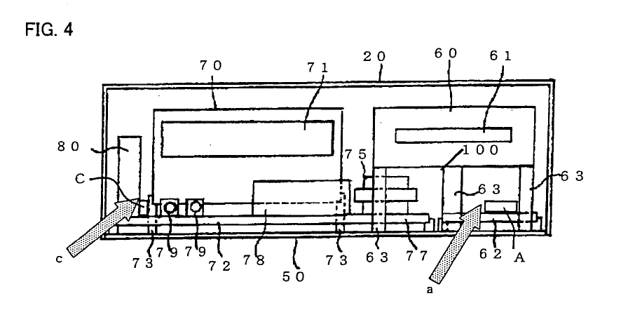

As shown in FIGS. 3 and 4, a DVD control circuit board 62 is arranged between the DVD recording/reading unit 60 and the bottom frame 50, and a VCR control circuit board 72 is arranged between the video cassette recording and reading unit 70 and the bottom frame 50. Also, between the DVD control circuit board 62 and the VCR control circuit board 72 is arranged a power circuit board 77. Although in the present invention, the VCR control circuit board 72 and the power circuit board 77 are united having a single body, however, they may be formed in separate structures when required by circuit configuration designing. In any case, a transformer having a height is to be mounted on the power circuit board 77, and therefore, it is preferred that the power circuit board 77 be disposed between the DVD recording/reading unit 60, which provides an allowance for height, and the bottom frame 50 (refer to FIG. 4).

In the embodiment shown in FIG. 3, the front end of the DVD control circuit board 62 is disposed so as to be positioned behind the two supporting struts 63, 63 that are fixed on the front surface, and a notched part 64 is formed in a position coinciding with the part where the remaining supporting strut 63 on the back side is attached. By disposing the remaining supporting struts 63 between the DVD control circuit board 62 and the power circuit board 77 in this manner, it is unnecessary to form a hole through which the supporting strut 63 pierces into the DVD control circuit board 62. Also, an attaching hole 74 through which the supporting strut 73 pierces is formed in the VCR control circuit board 72, and a notched part is formed in the attaching part of the supporting strut 63 that is fixed on the front surface.

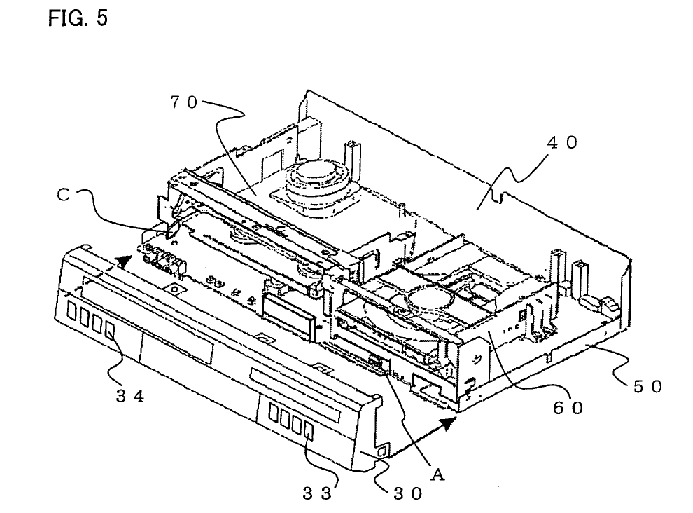

FIG. 4 is a front view that shows how parts are attached to the top surface of the bottom frame 50 as viewed from the front direction, and FIG. 5 is a perspective view of these parts as viewed slantly from above. As shown in FIG. 4, because of the difference in size between the video cassette tape medium and the DVD optical disk medium, the DVD recording/reading unit 60 has a smaller height than the video cassette recording and reading unit 70, and therefore, an empty space is created between the DVD recording/reading unit 60 and the bottom frame 50 when the position of the loading space 61 for a DVD medium is made substantially the same height as the loading slot 71 of the video cassette medium. And the DVD control circuit board 62 and the power circuit board 77 are disposed in this empty space.

Because the empty space under the DVD recording/reading unit 60 provides an allowance for height to a certain degree, wiring patterns are formed on both sides of the DVD control circuit board 62 to perform the double side mounting of electronic parts, thereby making the size of the board 62 compact, and the board 62 is formed in a shape that is elongate in the back and forth directions, thereby making it possible to provide a sufficient space for disposing the power circuit board 77. Although parts such as a transformer 75 are mounted on the power circuit board 77, a bulky transformer 75 can be disposed in the empty space under the DVD recording/reading unit 60 because the unit 60 provides an allowance for height to a certain extent.

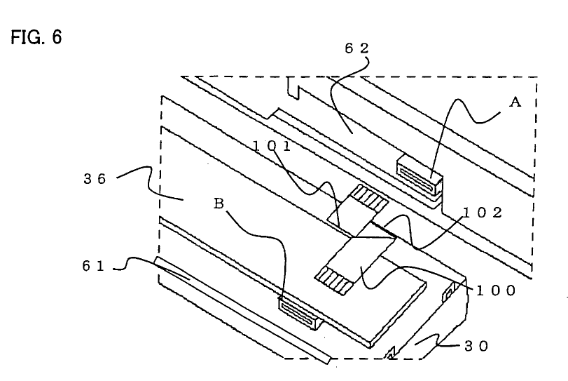

In FIG. 4, a connector (A) is disposed in the part indicated by the arrow a in the space between the DVD recording/reading unit 60 and the DVD control circuit board 62 in order to transmit operation signals of the operation buttons 33 of the DVD recording/reading unit 60 to the operation control circuit on the DVD control circuit board 62. The details of the state of this connection are shown in FIG. 6. On a circuit board for operation button control 36 to transmit operation signals of the operation buttons 33 of the DVD recording/reading unit 60 disposed on the back surface of the front operation panel 30 to the operation control circuit on the DVD control circuit board 62, a connector (B) is disposed and connected to the connector (A) on the DVD control circuit board 62 by an FFC 100, which is bent or folded in a Z-shaped form by mountain folding 101 and valley folding 102. At this time, it is important that the FFC 100 be bent or folded in such a manner that the mountain folding part 101 of the FFC 100 is positioned below the height of the medium loading slot 61 of the DVD recording/reading unit 60.

As shown in FIG. 4, the mounting space of the VCR control circuit board 72 is narrowly formed because a wiring pattern is formed on the bottom surface of the board 72 and the single side mounting of electronic parts is performed. In this case, it is also possible to narrowly form the mounting space in the vertical direction by mounting electronic parts having leads on the top surface and soldering on the bottom surface. Furthermore, for the part where the video cassette recording and reading unit 70 is mounted, the mounting space is prevented from becoming wide by mounting electronic parts having a low height, such as chip components. And because the height of the video cassette recording and reading unit 60 is the largest of all parts disposed within the cabinet of the complex electronic device 10, it is possible to reduce the height of the complex electronic device 10 by making the thickness of the VCR control circuit board 72 as small as possible. A display device 78 and external connection terminals 79, 79 are connected directly to the front end of the VCR control circuit board 72.

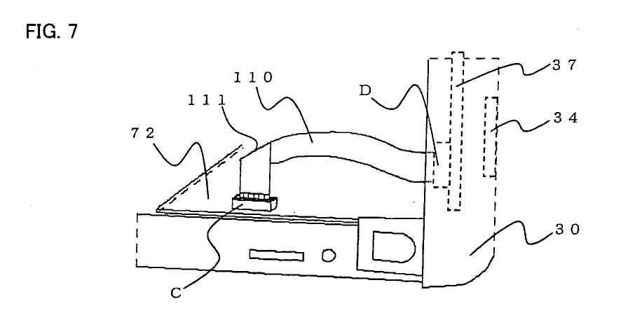

In FIG. 4, a connector (C) is disposed in the part indicated by the arrow c in the space above the VCR control circuit board 72 beside video cassette recording and reading unit 70 in order to transmit operation signals of the operation buttons 34 of the video cassette recording and reading unit 70 to an operation control circuit on the VCR control circuit board 72. The details of the state of the connection are shown in FIG. 7. On a circuit board for operation button control 37 to transmit operation signals of the operation buttons 34 of the video cassette recording and reading unit 70 disposed on the back surface of the front operation panel 30 to the operation control circuit on the VCR control circuit board 72, a connector (D) is disposed and connected to the connector (C) on the VCR control circuit board 72 by an FFC 110, which is bent or folded 90 degrees between the connector (C) on the VCR control circuit board 72 and the connector (D) on the circuit board for operation button control 37. At this time, it is important that the FFC 110 that is bent or folded 90 degrees extend from the connector (D) on the circuit board for operation button control 37 along the side surface of the VCR control circuit board 72 toward the back side of the device and be bent or folded 90 degrees above the connector (C).

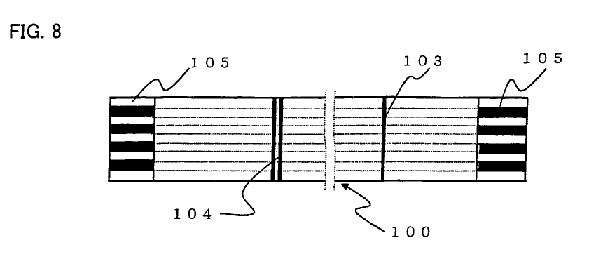

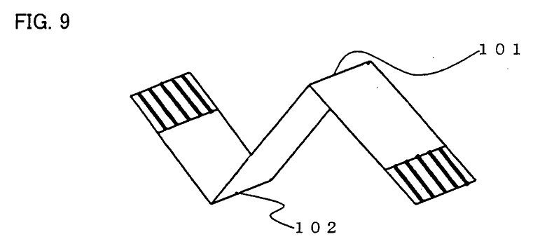

The details of the FFC 100 that is bent or folded in a Z-shaped form by the mountain folding 101 and the valley folding 102 will be given by using FIGS. 8 and 9. Because the FFC itself is a conventionally publicly known cable, its structure is not described here, but in the embodiment, it is a cable with multiple conductors arranged in parallel, the conductors having their top and bottom surfaces covered, and being exposed by stripping the covered parts at both ends. It is known that in bending or folding the FFC 100, marks to indicate the bending or folding positions are printed. However, in order to simultaneously indicate how to bend or fold the FFC 100, it is necessary to indicate the mountain folding 101 and the valley folding 102 with a different mark. In this embodiment, one solid line is used as a line 103 that indicates mountain folding and two parallel solid lines are used as lines 104 that indicate the valley folding. Of course, as this is a predetermined matter, they may be indicated by using a dotted line or an alternate long and short dash line, or alternatively by printing the letters “mountain folding” and “valley folding” beside one solid line. However, it is important that in any method, mountain folding or valley folding can be performed in an accurate position.

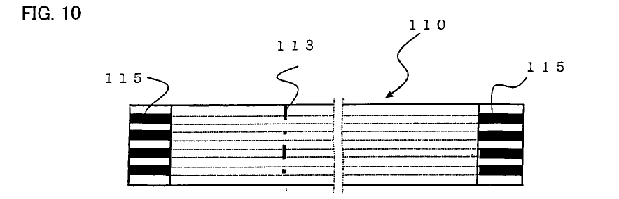

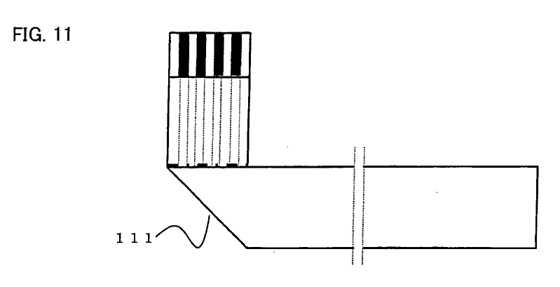

The details of the FFC 110 that is bent or folded 90 degrees will be described by using FIGS. 10 and 11. In this embodiment, one alternate long and short dash line is used as a line 113 that indicates 90 degree bending and folding position. Of course, as this is also a predetermined matter, they may be indicated by using a solid line or a dotted line, or alternatively by printing the letters “90 degree bending or folding” beside one solid line. In this embodiment, the position where the side surface of the FFC 110 is to be positioned after the 90 degree bending or folding is indicated. However, the position where the FFC 110 is to be bent or folded (indicated by an indication line that is 40 degree aslant to the FFC 110) maybe indicated. It is important that in any method, 90 degree bending or folding can be performed in an accurate position.

1. A complex electronic device in which within a cabinet are arranged an optical disk recording/reading unit having a front surface on which a loading space for an optical disk medium is provided and a video cassette recording and reading unit having a front surface on which a loading space for a video cassette medium is provided, and the units are supported by multiple supporting struts and arranged in parallel, the height of the supporting struts of said optical disk recording/reading unit being higher than the height of the supporting struts of said video cassette recording and reading unit so that the medium loading spaces have substantially the same height;
said cabinet having a front surface on which a front operation panel is provided, said front operation panel having operation buttons that operate each of said optical disk recording/reading unit and said video cassette recording and reading unit, on a back surface of the front operation panel being arranged a circuit board for operation button control that transmits the operation of each operation button to each of said units, and between said optical disk recording/reading unit and a bottom surface of the cabinet there being disposed a first control circuit board on which a control circuit of the optical disk recording/reading unit is provided and between said video cassette recording and reading unit and the bottom surface of the cabinet there being disposed a second circuit board on which a control circuit of the video cassette recording and reading unit is provided;
in order to transmit operation signals of the operation buttons of said optical disk recording/reading unit to the operation control circuit on said first control circuit board, a connector (A) being arranged between said optical disk recording/reading unit and the first control circuit board disposed below the optical disk recording/reading unit and on a side facing the front of devices on the first control circuit board, the connector (A) on the first control circuit board and a connector (B) on said circuit board for operation button control being connected by a flexible flat cable that is bent or folded in a Z-shaped form by mountain folding and valley folding.

2. The complex electronic device according to claim 1, wherein said flexible flat cable that is bent or folded in a Z-shaped form by mountain folding and valley folding is bent or folded, at the back surface of said front operation panel, so as to be positioned below the loading space for an optical disk medium, thereby not to be a hindrance to the loading of an optical disk medium.

3. A complex electronic device in which within a cabinet are arranged an optical disk recording/reading unit having a front surface on which a loading space for an optical disk medium is provided and a video cassette recording and reading unit having a front surface on which a loading space for a video cassette medium is provided, and the units are supported by multiple supporting struts and arranged in parallel, the height of the supporting struts of said optical disk recording/reading unit being higher than the height of the supporting struts of said video cassette recording and reading unit so that the medium loading spaces have almost the same height;
said cabinet having a front surface on which a front operation panel is provided, said front operation panel having operation buttons that operate each of said optical disk recording/reading unit and said video cassette recording and reading unit, on a back surface of the front operation panel being arranged a circuit board for operation button control that transmits the operation of each operation button to each of said units, and between said optical disk recording/reading unit and a bottom surface of the cabinet there being disposed a first control circuit board on which a control circuit of the optical disk recording/reading unit is provided and between said video cassette recording and reading unit and the bottom surface of the cabinet there being disposed a second circuit board on which a control circuit of the video cassette recording and reading unit is provided;
in order to transmit operation signals of the operation buttons of said video cassette recording and reading unit to the operation control circuit on said second control circuit board, a connector (C) being arranged between said video cassette recording and reading unit and the second control circuit board disposed below the video cassette recording and reading unit and on a side facing the side of devices on the second control circuit board, the connector (C) on the second control circuit board and a connector (D) on said circuit board for operation button control being connected by a flexible flat cable that is bent or folded 90 degrees.

4. The complex electronic device according to claim 3, wherein said flexible flat cable that is bent or folded 90 degrees extends from the connector (D) on said circuit board for operation button control along the side surface of said second control circuit board toward the back side of the device and is bent or folded 90 degrees above the connector (C).

5. A complex electronic device in which within a cabinet are arranged an optical disk recording/reading unit having a front surface on which a loading space for an optical disk medium is provided and a video cassette recording and reading unit having a front surface on which a loading space for a video cassette medium is provided, and the units are supported by multiple supporting struts and arranged in parallel, the height of the supporting struts of said optical disk recording/reading unit being higher than the height of the supporting struts of said video cassette recording and reading unit so that the medium loading space have substantially the same height;
said cabinet having a front surface on which a front operation panel is provided, said front operation panel having operation buttons that operate each of said optical disk recording/reading unit and said video cassette recording and reading unit, on a back surface of the front operation panel being arranged a circuit board for operation button control that transmits the operation of each operation button to each of said units, and between said optical disk recording/reading unit and a bottom surface of the cabinet there being disposed a first control circuit board on which a control circuit of the optical disk recording/reading unit is provided and between said video cassette recording and reading unit and the bottom surface of the cabinet there being disposed a second circuit board on which a control circuit of the video cassette recording and reading unit is provided;
in order to transmit operation signals of the operation buttons of said optical disk recording/reading unit to the operation control circuit on said first control circuit board, a connector (A) being arranged between said optical disk recording/reading unit and the first control circuit board disposed below the optical disk recording/reading unit and on a side facing the front of devices on the first control circuit board, the connector (A) on the first control circuit board and a connector (B) on said circuit board for operation button control being connected by a flexible flat cable that is bent or folded in a Z-shaped form by mountain folding and valley folding;
furthermore, in order to transmit operation signals of the operation buttons of said video cassette recording and reading unit to the operation control circuit on said second control circuit board, a connector (C) being arranged between said video cassette recording and reading unit and the second control circuit board disposed below the video cassette recording and reading unit and on a side facing the side of devices on the second control circuit board, the connector (C) on the second control circuit board and a connector (D) on said circuit board for operation button control being connected by a flexible flat cable that is bent or folded 90 degrees.

6. The complex electronic device according to claim 5, wherein said flexible flat cable that is bent or folded in a Z-shaped form by mountain folding and valley folding is bent or folded, at the back surface of said front operation panel, so as to be positioned below the loading space for an optical disk medium, thereby not to be a hindrance to the loading of an optical disk medium
and wherein said flexible flat cable that is bent or folded 90 degrees extends from the connector (D) on said circuit board for operation button control along the side surface of said second control circuit board toward the back side of devices and is bent or folded 90 degrees above the connector (C).

7. A flexible flat cable that indicates bending or folding positions, wherein indications that specify a position of mountain folding and a position of valley folding are provided so that in positions of the respective indications, mountain folding and valley folding can be accurately performed.

8. A flexible flat cable that indicates a bending or folding position, wherein an indication that specifies a position of 90 degree bending is provided so that 90 degree bending or folding can be performed in the position of the indication.
